(19) United States
(12) Patent Application Publication
(10) Pub. No.: US 2016/0281913 A1
(43) Pub. Date: Sep. 29, 2016

(54) MULTI-PURPOSE ELECTRONIC DEVICE HOLDER USED FOR SELFIE AND IN A CAR

(71) Applicants: Chung-Han TSAI, New Taipei City (TW); Ming-Hung SUN, New Taipei City (TW); Peter MOK, New Taipei City (TW)

(72) Inventors: Chung-Han TSAI, New Taipei City (TW); Ming-Hung SUN, New Taipei City (TW); Peter MOK, New Taipei City (TW)

(21) Appl. No.: 14/937,288

(22) Filed: Nov. 10, 2015

(30) Foreign Application Priority Data
Mar. 26, 2015 (TW) 104204540

(51) Int. Cl. F16M 13/02; H04M 1/04; F16M 13/04; A45F 5/00; H04B 1/3877; B60R 11/02

(52) U.S. Cl. CPC F16M 13/02; H04B 1/3877; B60R 11/02; F16M 13/04; A45F 5/00; H04M 1/04; A45F 2200/0516

(57) ABSTRACT

A multi-purpose electronic device holder used for selfie and in a car comprises a gripping unit clamped elastically on a flange at a periphery of dashboard in front of a driver's seat. The gripping unit includes a first coupling rod slidably provided with a screwing element. The screwing element is optionally screwed to a second coupling rod having an electronic device fixing mount or to a selfie stick. When an electronic device is limited and fixed by the electronic device fixing mount clamped on the flange at the periphery of dashboard, the electronic device is fixed in front of the driver who will not need to lean forward deliberately to operate the electronic device. Moreover, when getting off the car, the driver can easily remove the second coupling rod from the first coupling rod to carry or adapt the second coupling rod onto the selfie stick for selfie.

### BACKGROUND OF THE INVENTION

(a) Field of the Invention

The present invention relates to an electronic device holder, and more particularly to an electronic device holder with a dual purpose of being used for selfie and in a car.

(b) Description of the Prior Art

As the progress of technology, the application of electronic device, especially a smart phone, has been very versatile. Through a built-in GPS (Global Positioning System) device, locations can be provided when a person is driving a car, with an ordinary electronic device being used along with a holder. In general, the holder is attached on a front windshield with a sucking disc, allowing a user to operate or access the traffic information through the electronic device that is installed on the holder without grabbing the electronic device by hands.

However, the conventional holder 10 is fixed on the sucking disc 11 on the windshield (as shown in FIG. 1), and therefore, the holder 10 can fall out easily by wobbling or inertia in driving due to that the suction force of sucking disc 11 is decreased significantly, as the silicon material making the sucking disc 11 is usually hardened by direct sunlight or high temperature, after the sucking disc 11 has been used for a long time. This will affect the safety of driving severely. Moreover, as the holder 10 is fixed on the windshield at a position that is usually far away from a driver, the content on the electronic device will not be seen clearly, and the driver will have to lean forward deliberately to get close to the electronic device that he or she will move away from the back of driver's seat, when the electronic device is to be operated.

Accordingly, the present invention is to improve the abovementioned shortcomings effectively.

### SUMMARY OF THE INVENTION

The present invention discloses a multi-purpose electronic device holder which is used for selfie and in a car. The electronic device holder includes a gripping unit, a first coupling rod, a second coupling rod and an electronic device fixing mount.

The gripping unit is fixed on a flange formed at a periphery of dashboard in front of the driver's seat. The gripping unit is provided with a first jaw and a second jaw. A front end of the first jaw is a first gripping part and a front end of the second jaw is a second gripping part. The tail ends of the first jaw and the second jaw are pivoted together by a pin, allowing the first jaw to be clamped with the second jaw with the pin as an axis.

The first coupling rod is fixed on a top at an exterior side of the first jaw on the gripping unit; whereas, the other end of the first coupling rod is provided with a screwing element.

The second coupling rod is provided with a screwing element fitting unit on an end corresponding to the screwing element of the first coupling rod.

The electronic device fixing mount includes a main body and a limiting block. The main body is pivoted at the other end of the second coupling rod, and the limiting block is protruded at a periphery of the main body.

Accordingly, by clamping the abovementioned multi-purpose electronic device holder used for selfie and in a car on the flange of dashboard in front of the driver's seat, the position at which the electronic device fixing mount is installed will be further close to the driver to facilitate using the electronic device. In addition, the gripping unit also provides a better elastic clamping force without worrying about that the holder will drop out accidently or is aging to reduce the clamping force when the user is driving a car. Besides that, the first coupling rod and the second coupling rod can be dismantled or fixed easily by the screwing element and the screwing element fitting unit; whereas, the second coupling rod can be connected to a selfie stick with a screwing element in the same specification.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of installation of a conventional electronic device holder.

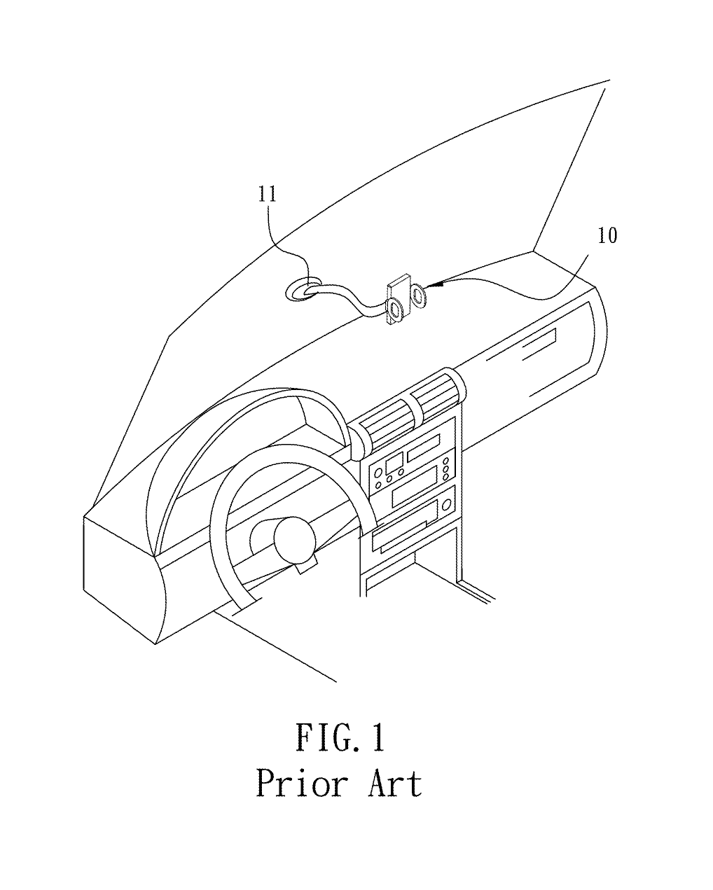

FIG. 2 shows a three-dimensional schematic view of the present invention.

FIG. 3 shows a three-dimensional exploded view of a gripping unit of the present invention.

FIG. 4 shows a local cutaway view of a location at which a first coupling rod is combined with a second coupling rod, according to the present invention.

FIG. 5 shows a three-dimensional schematic view of installation of the present invention.

FIG. 6 shows a side schematic view of installation of the present invention.

FIG. 7 shows a schematic view of installation of a selfie stick of the present invention.

### DETAILED DESCRIPTION OF THE PREFERRED EMBODIMENTS

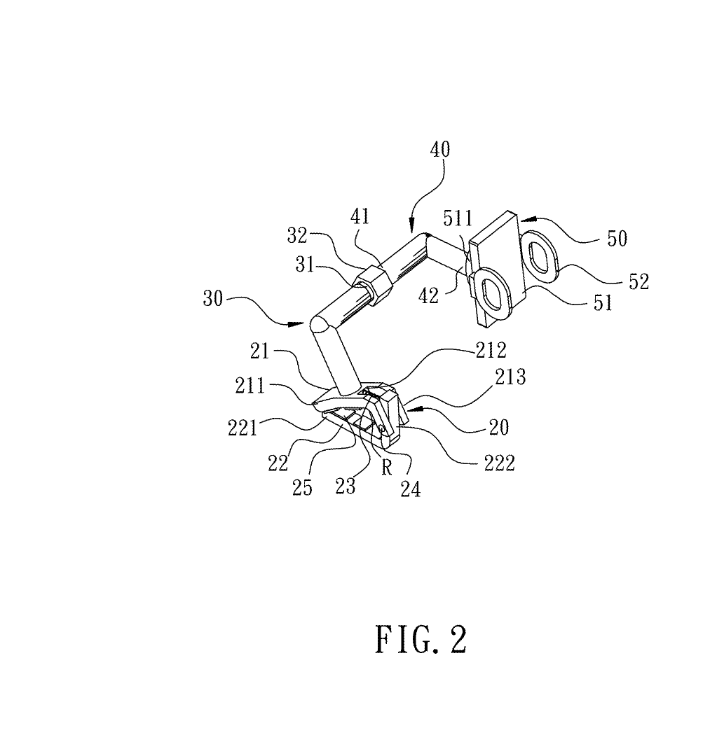

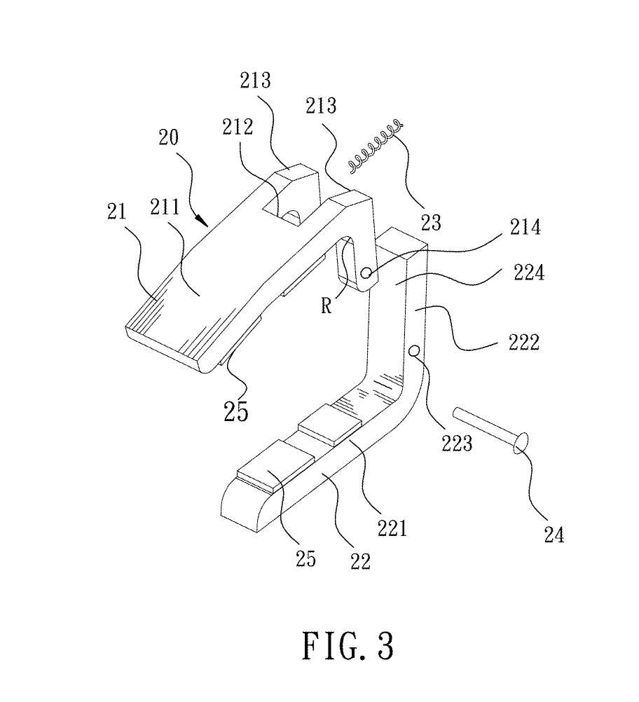

Referring to FIG. 2 and FIG. 3, it shows a three-dimensional schematic view of the present invention and a three-dimensional exploded view of a gripping unit of the present invention. The present invention discloses a multi-purpose electronic device holder used for selfie and in a car, comprising a gripping unit 20, a first coupling rod 30, a second coupling rod 40, and an electronic device fixing mount 50.

The gripping unit 20 is formed by a first jaw 21, a second jaw 22 and an elastic element 23, wherein a bending part R at a bended angle is disposed between a front and rear end of the first jaw 21, the front end of first jaw 21 is defined as a first gripping part 211, a tail end of the first gripping part 211 is provided with a first blocking part 212 close to the bending part R, two sides of the first blocking part 212 are protruded downward with two parallel pivoting rods 213 to form the rear end of the first jaw 21, and the pivoting rods 213 are coaxially penetrated with a through-hole 214.

A front end of the second jaw 22 is a second gripping part 221, the second jaw 22 is protruded upwardly and vertically with a toggling rod 222 at a tail end of the second gripping part 221, the toggling rod 222 is penetrated with a perforation 223 close to the second gripping part 221, and an inner surface of the toggling rod 222 is defined as a second blocking part 224 corresponding to the first blocking part 212. This means that the toggling rod 222 of the second jaw 22 is installed between the two parallel pivoting rods 213 of the first jaw 21, and the through-hole 214 of the pivoting rods 213 at the rear end of the first jaw 21 is pivoted with the perforation 223 of the second jaw 22 by a pin 24, allowing the first jaw 21 to be clamped with the second jaw 22 with the pin 24 as an axis to change the distance between the first gripping part 211 and the second gripping part 221. The elastic element 23 is disposed between the first blocking part 212 and the second blocking part 224 to provide an elastic force; whereas, an elastic thrust force is formed by the elastic element 23 to compress the first blocking part 212 and the second blocking part 224 to result in a clamping action, keeping the first gripping part 211 and the second gripping part 221 at being clamped. In addition, elastic cushions 25 are disposed inside the first gripping part 211 and the second gripping part 221.

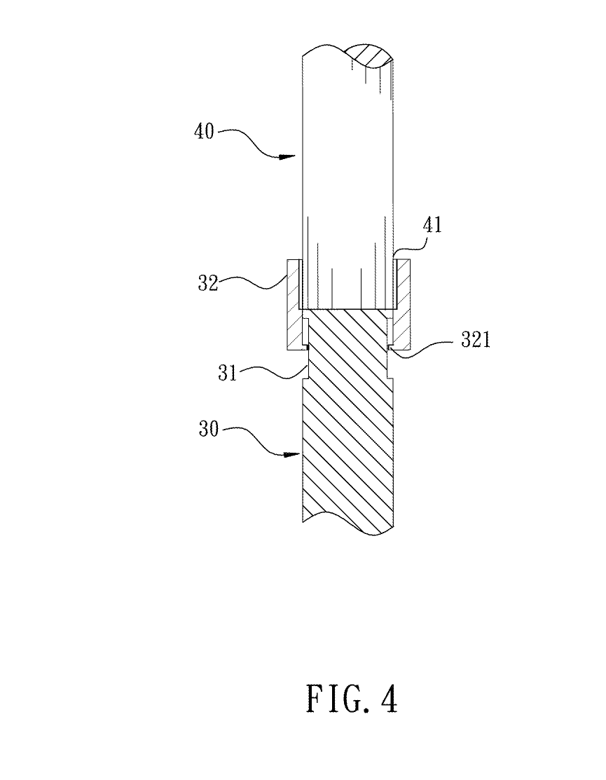

Referring to FIG. 2 and FIG. 4, it shows a local cutaway view of a location at which the first coupling rod is combined with the second coupling rod. The first coupling rod 30 is fixed on a top at an exterior side of the first jaw 21, and the other end of the first coupling rod 30 is provided with a neck part 31. The neck part 31 is used primarily to limit the screwing element 32, allowing the screwing element 32 to displace up and down or rotate clockwise and counterclockwise within a range formed by the neck part 31, so that the screwing element 32 can move back and forward on the neck part 31.

An end of the second coupling rod 40 is provided with a screwing element fitting unit 41 corresponding to the screwing element 32 of the first coupling rod 30.

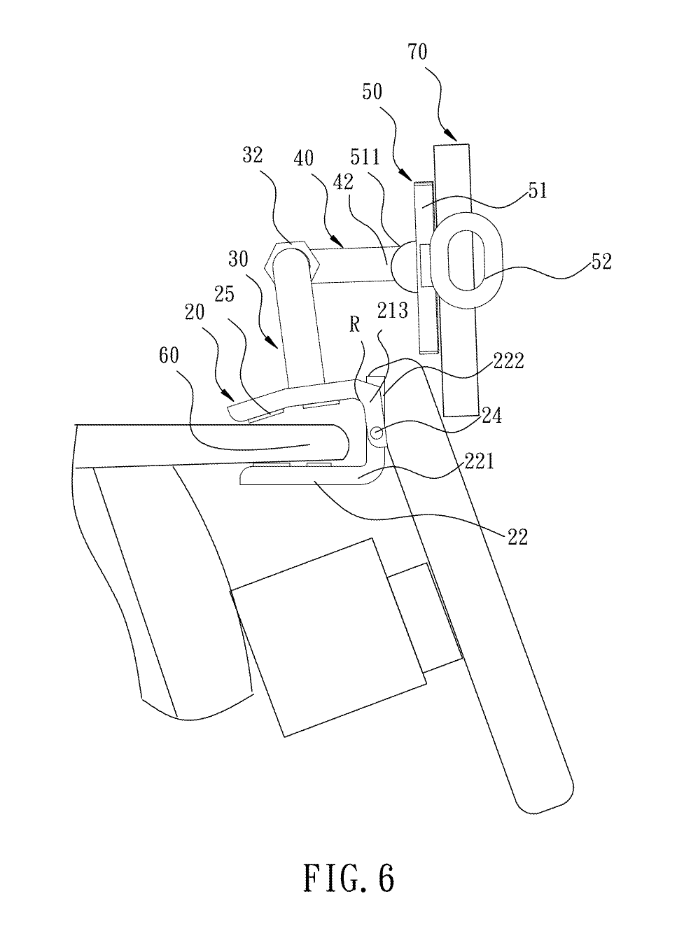

The electronic device fixing mount 50 includes a main body 51 and a limiting block 52. The main body 51 is pivoted at a connecting end 42 (not shown in the drawings) by a universal connector 511 (as shown in FIG. 6), and the limiting block 52 is protruded at a periphery of the main body 51.

For further understanding the characteristics, the technical means and the expected functions of the present invention, the method of using the present invention is described below.

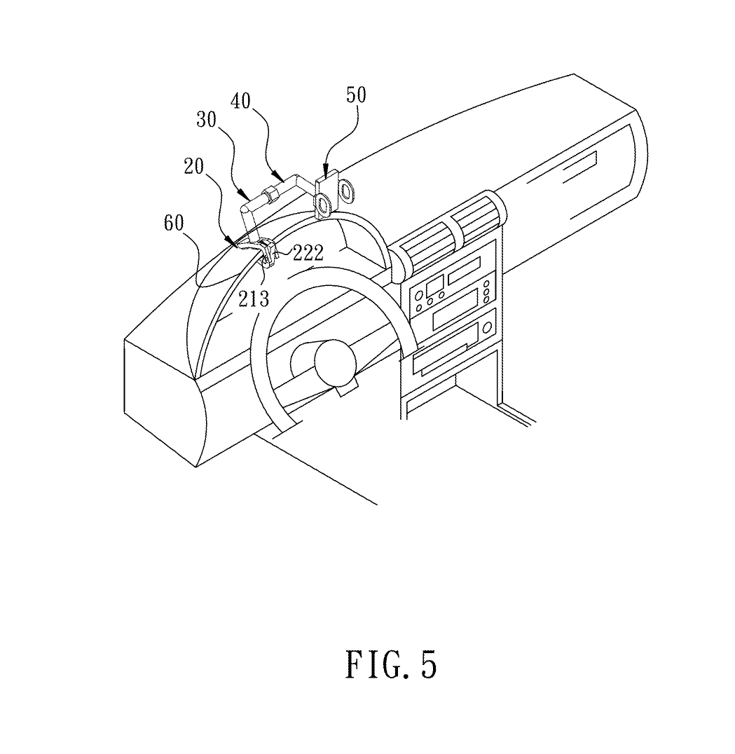

Referring to FIG. 3, FIG. 5 and FIG. 6, it shows a three-dimensional schematic view and a side schematic view of installation of the present invention. When the gripping unit 20 is to be installed, the elastic force provided by the elastic element 23 between the first blocking part 212 and the second blocking part 224 should first be overcome by exerting a force. The force is exerted directly by hands onto the toggling rod 222, allowing the toggling rod 222 to move backward (approaching the pivoting rods 213), so that the first gripping part 211 and the second gripping part 221 will expand outward as an opening with the pin 24 as an axis. Next, this opening is emplaced on a flange 60 of dashboard in front of the driver's seat, and then the toggling rod 222 is released, so that the elastic force of the elastic element 23 can push outward the first blocking part 212 and the second blocking part 224, resulting in an elastic clamping force to clamp the flange 60.

As shown in FIG. 4 again, when the first coupling rod 30 and the second coupling rod 40 are to be installed, the screwing element 32 and the screwing element fitting unit 41 are aligned first, and then the screwing element 32 is screwed into the screwing element fitting unit 41, thereby screwing the two as one part. When the first coupling rod 30 and the second coupling rod 40 are to be dismantled, the screwing element 32 is rotated counterclockwise and then the screwing element fitting unit 41 will be separated from the screwing element 32. As the screwing element 32 displaces up and down or rotates clockwise and counterclockwise only within the range formed by the neck part 31 of the first coupling rod 30, the first coupling rod 30 will not rotate with respect to the second coupling rod 40, no matter when the coupling rods are assembled or dismantled. Therefore, the coupling rods will not collide with an object in the car (such as a steering wheel) to interfere with the installation.

Referring to FIG. 6, when an electronic device 70 is to be installed on the electronic device fixing mount 50, the electronic device 70 is first emplaced on the main body 51 and then the position of the limiting block 52 is adjusted, such that the electronic device 70 can be limited and fixed on the main body 51. The universal connector 511 on the main body 51 can be used to adjust the direction of electronic device 70, allowing the driver to have a best line of vision.

After installation, the electronic device 70 will be located on the flange 60 of dashboard and is close to the driver's seat to facilitate operating. In addition, the gripping unit 20 can result in a good clamping effect that the electronic device 70 will not fall out in driving. Moreover, the cushions 25 in the first jaw 21 and the second jaw 22 can form a good buffering effect, and can assure that the electronic device 70 be tightly clamped on the flange 60 in a different shape.

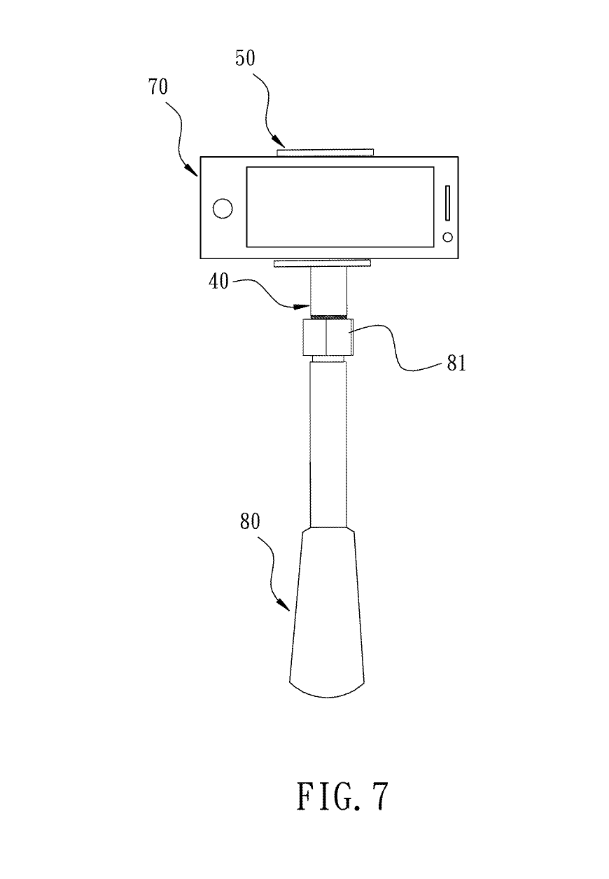

On the other hand, as shown in FIG. 7, when getting off the car, the driver can dismantle the second coupling rod 40 and take down the electronic device 70 as well as the electronic device fixing mount 50. The second coupling rod 40 can be screwed with a screwing element 81 of a selfie stick 80 which can be used as an assistant tool for taking pictures or as a support bracket, thereby increasing the area of application of the electronic device fixing mount 50 effectively.

It is to be understood that the above description and drawings are only used for illustrating some embodiments of the present invention, not intended to limit the scope thereof. Any variation and deviation from the above description and drawings should be included in the scope of the present invention.

What is claimed is:

1. A multi-purpose electronic device holder used for selfie and in a car, comprising:
a gripping unit, wherein the gripping unit being provided with a first jaw and a second jaw, a bending part being disposed between a front and rear end of the first jaw, the front end of first jaw being a first gripping part, the first gripping part being provided with a first blocking part close to the bending part, two sides of the first blocking part being bended and protruded downward with two parallel pivoting rods; a front end of the second jaw being a second gripping part, the second jaw being protruded upward and vertically with a toggling rod at a tail end of the second gripping part, an inner surface of the toggling rod being defined as a second blocking part corresponding to the first blocking part, an elastic element being disposed between the first blocking part and the second blocking part to provide an elastic force, and the toggling rod being pivoted between the two pivoting rods;
a first coupling rod, an end of the first coupling rod being fixed at the first jaw, the other end of the first coupling rod being provided with a neck part, and an interior of the neck part being slidably provided with a screwing element;
a second coupling rod, an end of the second coupling rod being screwed with a screwing element fitting unit corresponding to the screwing element to fix with the screwing element; and
an electronic device fixing mount, the electronic device fixing mount being provided with a main body and a limiting block, the main body being disposed at other end of the second coupling rod, and the limiting block being protruded at a periphery of the main body.

2. The multi-purpose electronic device holder used for selfie and in a car, according to claim 1, wherein a selfie stick is further included, with a top end of the selfie stick being provided with a screwing element to screw and fix with the screwing element fitting unit of the second coupling rod.

3. The multi-purpose electronic device holder used for selfie and in a car, according to claim 1, wherein the first gripping part and the second gripping part are provided with a cushion.
